(19) United States
(12) Patent Application Publication
(10) Pub. No.: US 2024/0174023 A1
(43) Pub. Date: May 30, 2024

(54) Bicycle Rim Structure

(71) Applicant: HSIN CHUAN IND. CO., LTD., Changhua County (TW)

(72) Inventor: Yu-Ling Yang, Changhua County (TW)

(21) Appl. No.: 18/241,192

(22) Filed: Aug. 31, 2023

(30) Foreign Application Priority Data
Nov. 29, 2022 (TW) 111145559

(51) Int. Cl. B60B 21/06; B60B 1/04; B60B 21/02

(52) U.S. Cl. CPC B60B 21/062; B60B 1/044; B60B 21/025; B60B 21/064; B60B 1/003

(57) ABSTRACT

A bicycle rim structure includes a rim. The rim has two side portions, an inner annular portion, and an outer annular portion. The two side portions, the inner annular portion and the outer annular portion surround a hollow area. The inner annular portion has a thickness greater than that of the side portions to form an inner raised portion extending toward the hollow ara. An arc-shaped abutting groove is formed on the inner raised portion. The arc-shaped abutting groove is formed with a plurality of equally spaced spoke holes each configured to receive a spoke nipple. The spoke nipple has a head portion and a neck portion. One end of a spoke is connected to the neck portion. A surface of the curved abutting groove supports two sides of the head portion.

### BACKGROUND OF THE PRESENT INVENTION

### Field of Invention

The present invention relates to a bicycle rim structure, and more particularly to a rim having an inner annular portion with a thickness greater than that of two side portions. The inner annular portion is formed with an arc-shaped abutting groove. The surface of the arc-shaped abutting groove can support a spoke nipple with a large installation angle, so that the spoke nipple can be supported evenly to avoid damage to the spoke nipple and the spoke.

### Description of Related Arts

A conventional bicycle rim 10, as shown in FIGS. 1 to 3, the rim 10 has an inner annular portion 11 around its rotation axis C and a wheel drum 1. The inner annular portion 11 is formed with a plurality of equally spaced spoke holes 12. Each of the spoke holes 12 is provided with a spoke 13 installed at an angle. The spoke 13 is connected to a hub hole 2 of the wheel drum 1. A spoke nipple 14 is connected between the spoke hole 12 and the spoke 13. The spoke nipple 14 has a head portion 15 and a neck portion 16. One end of the spoke 13 is connected to the neck portion 16. The spoke nipple 14 is installed in the spoke hole 12. When the spoke 13 is connected to the wheel drum 1 from the spoke hole 12, the spoke nipple 14 and the spoke 13 are inclined at an angle or inclined to the left/right (as shown in FIG. 1). The spoke 13 is maintained in tension between the spoke nipple 14 and the wheel drum 1. In these days, electric bicycles are becoming more and more popular. The wheel drum 1 of the electric bicycle is equipped with a motor mechanism. Therefore, the wheel drum 1 of an electric bicycle is larger in size and outer diameter than the wheel drum 1 of a general bicycle. Correspondingly, left and right inclination angles of the spoke nipple 14 and the spoke 13 connected to the wheel drum 1 are bigger. The inclination angles may be up to 45°. Thus the spoke hole 12 of the rim 10 needs to match the angles of the spoke nipple 14 and the spoke 13. In other words, the spoke hole 12, the spoke nipple 14 and the spoke 13 are on the same axis. Referring to FIG. 2, the rim 10 usually cannot support the spoke nipple 14 installed at an angle of more than 8°. If the inclination angle of the spoke nipple 14 is not greater than 8°, most of the two sides of the head portion 15 of the spoke nipple 14 are supported by the inner annular portion 11. Even if the spoke nipple 14 is unevenly stressed when the spoke 13 is tightened, the spoke nipple 14 and the spoke 13 will not be damaged. Referring to FIG. 3, if the inclination angle of the spoke nipple 14 is too large, for example, 45°, only one side of the circumference of the head portion 15 of the spoke nipple 14 is supported by the inner annular portion 11, and the other side is not supported, so the head portion 15 of the spoke nipple 14 is not supported evenly. The greater the inclination angle, the more serious the unevenness. The stress concentration at the junction of the spoke nipple 14 and the spoke 13 causes a shear force to bend the spoke 13. As a result, the spoke nipple 14 and the spoke 13 may be damaged. Sometimes, the spoke 13 may break. How to make the spoke nipple 14 inclined at a large angle to be supported and stressed evenly is a goal that the industry still needs to work on.

### SUMMARY OF THE PRESENT INVENTION

In view of the shortcomings of the prior art, the primary object of the present invention is to provide a bicycle rim structure, comprising a rim. The rim has two side portions, an inner annular portion, and an outer annular portion. The inner annular portion has a thickness greater than that of the side portions to form an inner raised portion. The inner raised portion provides a space for an arc-shaped abutting groove to be recessed. The arc-shaped abutting groove is formed with a plurality of equally spaced spoke holes each arranged at a set angle, so that the spoke nipple with a larger installation angle can be evenly supported.

According to the above object, the present invention provides a bicycle rim structure, comprising a rim. The rim has two side portions, an inner annular portion, and an outer annular portion. Left and right sides of the inner annular portion are connected to bottom edges of the two side portions, respectively. Left and right sides of the outer annular portion are connected to top edges of the two side portions, respectively. A predetermined distance is defined between the inner annular portion and the outer annular portion. The two side portions, the inner annular portion and the outer annular portion surround a hollow area. The inner annular portion has a thickness greater than that of the side portions to form an inner raised portion extending toward the hollow area. An arc-shaped abutting groove is formed on the inner raised portion. The arc-shaped abutting groove is formed with a plurality of equally spaced spoke holes each configured to receive a spoke nipple. The spoke nipple has a head portion and a neck portion. One end of a spoke is connected to the neck portion. A cross-section of the arc-shaped abutting groove has a curved segment. The curved segment has a center. The spoke holes each have a central axis. The center serves as a reference point for the central axis to radially pass through the inner annular portion in a fan shape. The neck portion is assembled in a corresponding one of the spoke holes. A surface of the curved abutting groove supports two sides of the head portion.

In one embodiment of the present invention, when the central axis at a right angle is set as 0 degrees, a length of the curved segment is greater than a range of every adjacent two of the spoke holes at an angle of 45° relative to left and right sides of the central axis.

In one embodiment of the present invention, the thickness of the inner annular portion, in a position where the central axis perpendicularly passes through the inner annular portion, is between 2.0 mm and 2.5 mm.

In one embodiment of the present invention, an outer raised portion protrudes from one side of the inner annular portion away from the hollow area.

With the above structure, the concave surface of the arc-shaped abutting groove can support the head portion of the spoke nipple in a wide range, so that the spoke nipple with a larger installation angle can be evenly supported and stressed, thereby avoiding damage.

### BRIEF DESCRIPTION OF THE DRAWINGS

FIG. 1 is a partial front view of conventional spokes installed to a bicycle rim;

FIG. 2 is a schematic cross-sectional view of the conventional spoke installed at an angle of 8°;

FIG. 3 is a schematic cross-sectional view of the conventional spoke installed at an angle of 45°;

FIG. 4 is a partial perspective view of the present invention;

FIG. 5 is a cross-sectional view of the rim of the present invention;

FIG. 6 is a schematic cross-sectional view of the present invention, wherein the spoke nipple is installed at an angle of 8°;

FIG. 7 is a schematic cross-sectional view of the present invention, wherein the spoke nipple is installed at an angle of 45°; and

FIG. 8 is a schematic cross-sectional view of the present invention, wherein the inner annular portion has an outer raised portion.

### DETAILED DESCRIPTION OF THE PREFERRED EMBODIMENT

Embodiments of the present invention will now be described, by way of example only, with reference to the accompanying drawings.

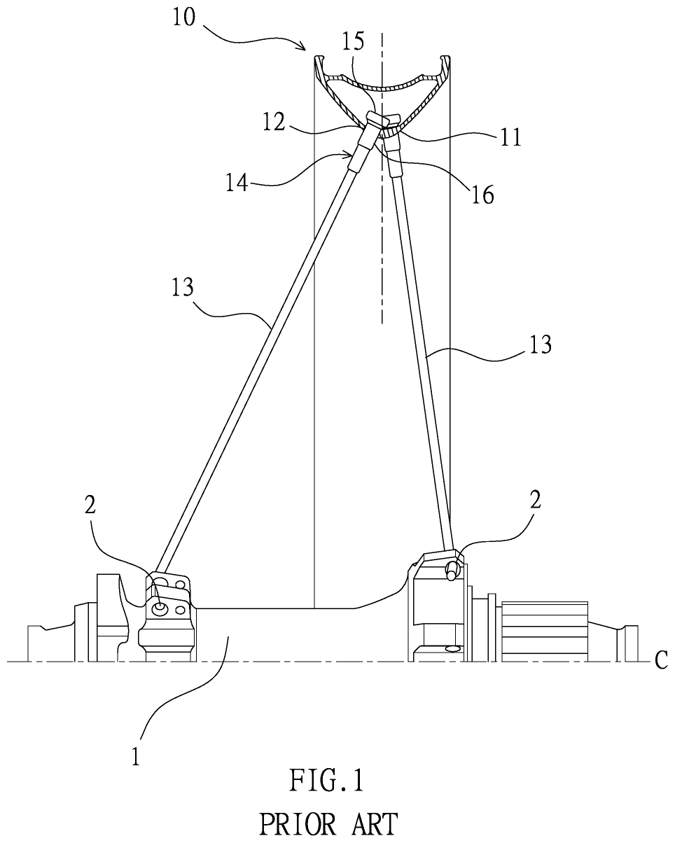

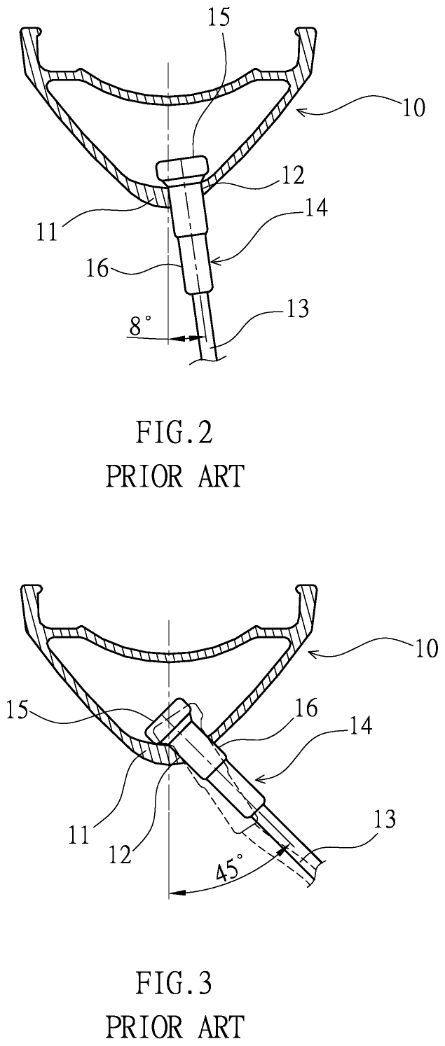

As shown in FIG. 1 through FIG. 4, the present invention discloses a bicycle rim structure, comprising a rim 20. The rim 20 is integrally made, and has two side portions 21, an inner annular portion 22, and an outer annular portion 23. The left and right sides of the inner annular portion 22 are integrally connected to the bottom edges of the two side portions 21, respectively. The left and right sides of the outer annular portion 23 are integrally connected to the top edges of the two side portions 21, respectively. A predetermined distance is defined between the inner annular portion 22 and the outer annular portion 23. The two side portions 21, the inner annular portion 22 and the outer annular portion 23 jointly surround a hollow area 24. The thickness of the inner annular portion 22 is greater than that of the side portions 21 to form an inner raised portion 25 extending toward the hollow area 24. An arc-shaped abutting groove 26 is formed on the circumference of the inner raised portion 25. The inner raised portion 25 enables the arc-shaped abutting groove 26 to be recessed. The arc-shaped abutting groove 26 is formed with a plurality of equally spaced spoke holes 27. Each of the spoke holes 27 is arranged at a set angle as required, and configured to receive a spoke nipple 30. The spoke nipple 30 has a head portion 31 and a neck portion 32. One end of a spoke 33 is connected to the neck portion 32. The cross section of the arc-shaped abutting groove 26 has a curved segment S. The curved segment S has a center O. The spoke hole 27 has a central axis N. The center O serves as a reference point for the central axis N to radially pass through the inner annular portion 22 in a fan shape. When the central axis N at a right angle is set as 0 degrees, the length of the curved segment S is greater than the range of every adjacent two of the spoke holes 27 at an angle of 45° relative to the left and right sides of the central axis N, so that the surface of the curved abutting groove 26 can support both sides of the head portion 31 of the spoke nipple 30. The thickness of the inner annular portion 22, in a position where the central axis N perpendicularly passes through the inner annular portion 22, is between 2.0 mm and 2.5 mm. With the above structure, the concave surface of the arc-shaped abutting groove 26 can support the head portion 31 of the spoke nipple 30 in a wide range, so that the spoke nipple 30 with a larger installation angle can be evenly supported and stressed, thereby avoiding damage.

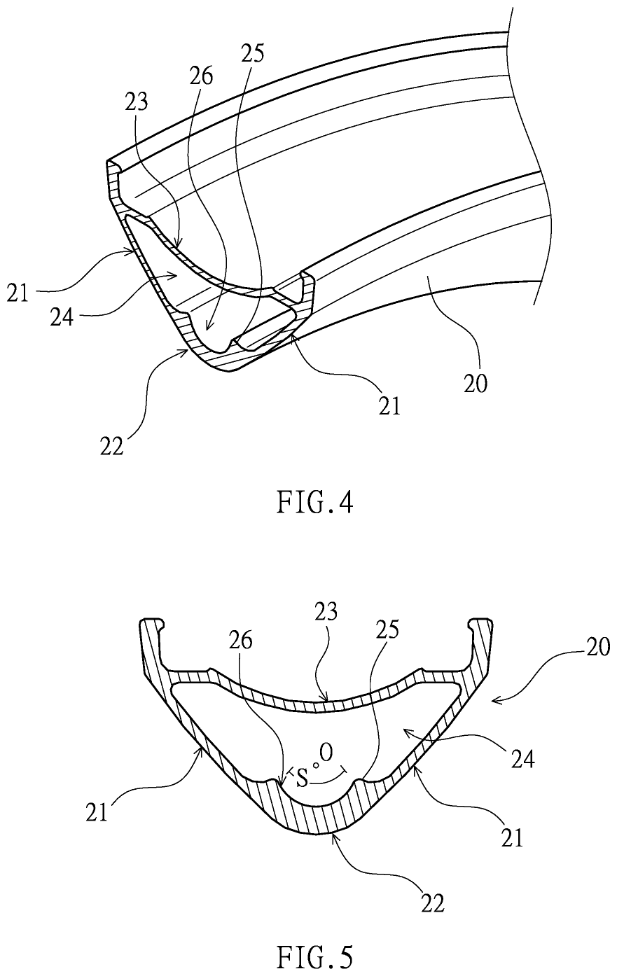

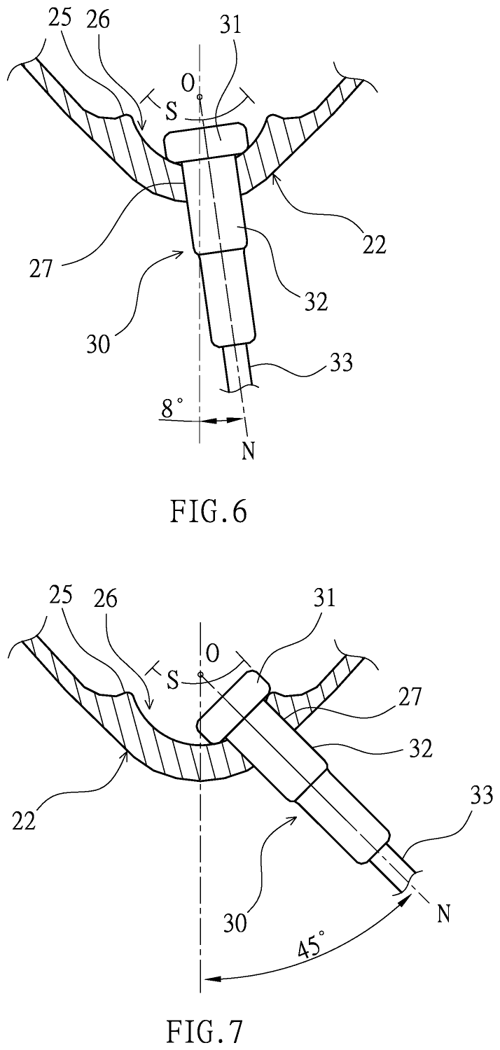

The assembly, function and effect of the above-mentioned embodiment are described in detail below. Referring to FIGS. 4 to 7, the rim 20 of the present invention is preferably made of metal by extrusion. Except the spoke holes 27, each section of the rim 20 shows a consistent thickness. The center O of the curved arc segment S serves as a reference point for the spoke hole 27 to pass through the surface of the arc-shaped abutting groove 26 at a set angle, that is, the central axis N is the normal of the curved segment S. In other words, both sides of the spoke hole 27 are symmetrical relative to the central axis N. Therefore, when the spoke nipple 30 is installed in the spoke hole 27, the bottom edge of the head portion 31 is in contact with both sides of the edge of the spoke hole 27. In this way, the spoke head 30 bears the tension of the spoke 33. The arc-shaped abutting groove 26 enables both sides of the spoke head 30 to be supported and stressed evenly, so that the spoke nipple 30 and the spoke 33 can be stabilized to avoid the concentrated stress (shear force) at the junction of the spoke nipple 30 and the spoke 33, so as to prevent the spoke nipple 30 and the spoke 33 from being damaged or to prevent the spoke 33 from breaking. Furthermore, the head portion 31 of the spoke nipple 30 can be stressed stably and evenly. Thus, the tensile strength that the spoke nipple 30 and the spoke 33 can bear is greater, and the rigidity effect is better. Because the spoke hole 27 can be arranged at any angle in the arc-shaped abutting groove 26, both sides of the head portion 31 of the spoke nipple 30 can be supported and stressed evenly. The curved segment S of the arc-shaped abutting groove 26 is designed for drilling a hole angled at an angle of 45° (90° relative to the left and right sides of the central axis N. Therefore, it can meet the requirements for the spokes to be mounted between the rim and the wheel drum of the electric bicycle, so that the rim provided by the present invention can be used widely. Besides, the thickness of the inner annular portion 22, in a position where the central axis N perpendicularly passes through the inner annular portion 22, is between 2.0 mm and 2.5 mm. This ensures that the rim 20 remains rigid and its weight is under control.

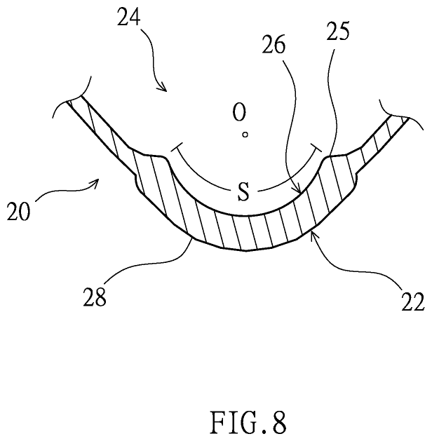

According to the above-mentioned creative idea, the present invention may implement and present the aspect as shown in FIG. 8. An outer raised portion 28 protrudes from one side of the inner annular portion 22 away from the hollow area 24. The outer raised portion 28 enables the rim 20 to be in a different shape, and enables the arc-shaped abutting groove 26 to be recessed inwardly. The radian of the arc-shaped abutting groove 26 may be larger, and the length of the curved segment S may be longer. Thus, the spoke nipple 30 with a larger inclination angle can be supported, so that the spoke nipple 30 with a large inclination angle can be supported evenly to avoid damage.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A bicycle rim structure, comprising a rim, the rim having two side portions, an inner annular portion and an outer annular portion; left and right sides of the inner annular portion being connected to bottom edges of the two side portions respectively, left and right sides of the outer annular portion being connected to top edges of the two side portions respectively, a predetermined distance being defined between the inner annular portion and the outer annular portion, the two side portions, the inner annular portion and the outer annular portion surrounding a hollow area; the inner annular portion having a thickness greater than that of the side portions to form an inner raised portion extending toward the hollow area, an arc-shaped abutting groove being formed on the inner raised portion, the arc-shaped abutting groove being formed with a plurality of equally spaced spoke holes each configured to receive a spoke nipple, the spoke nipple having a head portion and a neck portion, one end of a spoke being connected to the neck portion; a cross-section of the arc-shaped abutting groove having a curved segment, the curved segment having a center, the spoke holes each having a central axis, the center serving as a reference point for the central axis to radially pass through the inner annular portion in a fan shape, the neck portion being assembled in a corresponding one of the spoke holes, a surface of the curved abutting groove supporting two sides of the head portion.

2. The bicycle rim structure as claimed in claim 1, wherein when the central axis at a right angle is set as 0 degrees, a length of the curved segment is greater than a range of every adjacent two of the spoke holes at an angle of 45° relative to left and right sides of the central axis.

3. The bicycle rim structure as claimed in claim 1, wherein the thickness of the inner annular portion, in a position where the central axis perpendicularly passes through the inner annular portion, is between 2.0 mm and 2.5 mm.

4. The bicycle rim structure as claimed in claim 1, wherein an outer raised portion protrudes from one side of the inner annular portion away from the hollow area.
